(19) United States
(12) Patent Application Publication
(10) Pub. No.: US 2002/0055449 A1
(43) Pub. Date: May 9, 2002

(54) Laundry additive sachet

(75) Inventors: Antonella Porta, IT-Formia (IT); Mark Pieter Adrie Van Der Heijden, Rome (IT)

Correspondence Address: THE PROCTER & GAMBLE COMPANY, PATENT DIVISION, IVORYDALE TECHNICAL CENTER - BOX 474, 5299 SPRING GROVE AVENUE, CINCINNATI, OH, 45217, US

(73) Assignee: The Procter & Gamble Company

(21) Appl. No.: 09/898,740

(22) Filed: Jul. 3, 2001

(30) Foreign Application Priority Data
Jun. 7, 2000 (EP) 00870155.9

(51) Int. Cl. C11D 17/00

(52) U.S. Cl. 510/295; 510/297; 510/439

(57) ABSTRACT

The present invention relates to a laundry additive sachet. The sachet comprises a cavity in which is found a dye absorbing agent and a dirt binding agent. The sachet provides a system of scavenging fugitive dyes or pigments and dirt from laundry wash water.

### TECHNICAL FIELD

The present invention relates to a laundry additive for removing extraneous, fugitive dyes from laundry washing applications which contain dyed wash items from which fugitive dyes have been given up and wash items for which reassociation of such fugitive dyes is undesirable.

### BACKGROUND

During washing applications, there is often the problem that dyes or pigments are given up from the items being washed to the wash water. Whilst the degree to which the dyes are fabric substantive and the number of times the item has been washed are factors in the release of dye from wash items, the items will still invariably give up at least some dye during the washing process. The dyes given up by the fabrics, often called fugitive or stray dyes, can then redeposit or otherwise reassociate with other wash items in the wash water. This transfer of dye from one wash item to another wash item typically results in an unsatisfactory appearance of the item being washed, since while one item loosed colour intensity the other picks up spots of transferred dye.

One solution as described in the prior art has been to improve the fabric substantivity of the dyes themselves, such that less or no dye is given up from the wash item during the washing process. Such solutions have involved slow heating of the dye liquor, pre-treatment of textile fabrics to improve dye affinity, after-treatment of dyed fabrics and enhancement of the colour fastness of the individual dyes.

Alternative solutions have been to load the wash liquor with dye scavengers or dye transfer inhibitors, which when dissolved in the wash liquor bind the free dye compounds. The bound dye compounds can no longer then bind to the fabric. However, dye transfer inhibitors when used in large amounts have been found to limit the effectiveness of optical brighteners. And in extreme conditions it has also been found that dye transfer inhibitors may in fact contribute to the deterioration of dyes still present on the surface of the fabric, and colour fading. U.S. Pat. No. 5 698 476 relates to a system for scavenging fugitive dyes from the wash water and comprises a dye absorber and a dye transfer inhibitor supported on a support matrix. The support matrix is a sheet of woven or non-woven fibres. The applicants have found that whilst such a system is effective for scavenging fugitive dyes, the sheet comprising the dyes then remains in physical contact with the wash items in the wash.

It is thus an object of the present invention to provide a system for effectively scavenging or trapping fugitive dyes and pigments, then preventing the scavenged fugitive dyes and pigments from coming into physical contact with the wash items.

It has also been an object of the present invention to trap dirt in a similar way as that described already with a view to fugitive dyes. Hence as the dirt is removed from the wash items it is trapped and prevented from coming into contact with the wash items.

### SUMMARY OF THE INVENTION

According to the present invention there is provided a laundry additive sachet, the sachet defining a cavity, the laundry additive being located in the cavity and comprising a dye absorbing agent and/or dirt binding agent.

### DETAILED DESCRIPTION OF THE INVENTION

The sachet according to the present invention is designed to be used as a laundry additive meaning that the sachet is added to the laundry wash water, in conjunction with a conventional laundry detergent composition.

Sachet

The sachet of the present invention comprises a bag or pouch sealed on all sides and defining a cavity. By “sealed” it is meant that all edges of the sachet are secured closed such that the dye absorbing and dirt binding agents may be retained within the cavity of the sachet. The sachet is preferably manufactured from water permeable, water insoluble materials. The sachet may preferably be manufactured from a web. More preferably the web is manufactured from fibres which do not exhibit an affinity for the fugitive dye and/or dirt. Hence at the end of the washing process the sachet is substantially the same colour as when first used. The web may be woven or non-woven, foam, sponge, battings, balls, puffs or films but must be suitable for forming a sachet. Preferably the web is manufactured from a non-woven web comprising inert man-made, natural or synthetic fibres or mixtures thereof. More preferably the fibres do not comprise a permanent cationic charge.

According to the present invention the web may be produced by any methods known in the art. For example non-woven material substrates can be formed by dry forming techniques such as carding, air-laying or wet laying such as on a paper making machine. Other non-woven manufacturing techniques such as melt blown, spun bonded, needle punched and spun laced methods may also be used. A preferred method is air laying.

Natural fibres are those prepared from naturally occurring elements. Most preferably the natural fibres include cellulosic fibres e.g. cotton. Man-made fibres, includes fibres manufactured from cellulose, for example derivatives of or regenerated cellulose, and thus are distinguishable from synthetic fibres, which are based on synthetic organic polymers. A derivative fibre, as used herein, is a fibre formed when a chemical derivative of a natural polymer, e.g., cellulose, is prepared, dissolved, and extruded as a continuous filament, and the chemical nature of the derivative is retained after the fibre formation process. A regenerated fibre, as used herein, is a fibre formed when a natural polymer, or its chemical derivative, is dissolved and extruded as a continuous filament. Whilst the physical nature of the natural polymer is changed, the chemical nature of the natural polymer is substantially retained or regenerated after the fibre formation process. Preferred man-made fibres used in the present invention include rayon (viscose) that is produced by dissolving cellulose fibres in N-methylmorpholine-N-oxide, resulting in what is known as regenerated cellulosic fibres and which are supplied by Tencel Fibres Europe, UK. Preferred synthetic fibres include polyurethane, polypropylene, polyester, polyethylene, polyamide, polyethylene tetraphthalate (PET) and mixtures thereof. In a preferred embodiment the web is composed of synthetic fibres, more preferably polypropylene fibres.

The web preferably has a weight of at least 20 gm⁻² and preferably less than 150 gm⁻², and most preferably the base weight is in the range of 20 gm⁻² to 100 gm⁻², more preferably from 40 gm⁻² to 70 gm^{-2.} The web may have any caliper. Typically, the web has the average web caliper of less than 1.0 mm. More preferably the average caliper of the web is from 0.2 mm to 0.9 mm. The web caliper is measured according to standard EDANA Non-woven Industry Methodology, reference method # 30.4-89.

In addition to the fibres used to make the web, the web can comprise other components or materials added thereto as known in the art, to improve appearance, surface texture, colour, and odour. An example is the use of opacifying agents, for example titanium dioxide or web substantive perfumes.

According to the present invention the web may comprise a binder to improve the physical strength of the sachet. The term “binder” as used herein describes any agent employed to interlock fibers. Such agents comprise wet strength resins and dry strength resins. It is often desirable particularly for cellulose based materials to add chemical substances known in the art as wet strength resins. A general dissertation on the types of wet strength resins utilised namely in the paper art can be found in TAPPI monograph series No. 29, Wet Strength in Paper and Paperboard, Technical Association of the Pulp and Paper Industry (New York, 1965). In addition to wet strength additives, it can also be desirable to include certain dry strength and lint control additives known in the art such as starch binders.

Preferred binders used to bond non-wovens are polymeric binders, preferably latex binders, more preferably waterborne latex binders. Suitable binders include butadiene-styrene emulsions, ethylene vinyl acetate emulsions, vinyl acetate, vinyl chloride and combinations thereof. Preferred latex binders are made from styrene, butadiene, acrylonitrile-butadiene emulsions or combination thereof.

The term non-acrylate binder, as used herein, encompasses all latex binders that do not comprise acrylic acid or acrylic acid ester or vinyl acetate monomers. Preferred binders according to the present invention include: Butadiene-styrene emulsions, carboxylated styrene-butadiene emulsion, Acrylonitrile-butadiene emulsions, polyacrylamide resins, Polyamide-epichlorohydrin resin, Acrylonitrile-Butadiene-Styrene emulsion, Styrene Acrylonitrile. The most preferred binder according the present invention is a butadiene-styrene emulsion, which can be commercially obtained from the Ameribol Svnpol Corp. as Rowene™ SB 5550.

The binder can be applied to the web by any method known in the art. Suitable methods include spraying, printing (e.g. flexographic printing), coating (e.g. gravure coating or flood coating), padding, foaming, impregnation, saturation and further extrusion whereby the binder is forced through tubes in contact with the substrate whilst the substrate passes across the tube or combinations of these application techniques. For example spraying the binder on a rotating surface such as calendar roll that then transfers the composition to the surface of the substrate. The most preferred method for the application of the binder is spraying onto the web. Most preferably the binder is sprayed onto one side of the web in one step of application and onto the other side of the web in a independent step of application.

Typically, the amount of the binder applied to the web, as measured in weight % of the dry weight of the fibres comprised by the web, is from 5% to 30%, more preferably from 10% to 25%, most preferably from 14% to 22%. Of course the amount of binder to be applied largely depends on the kind of web to be treated.

Alternatively strength of the web may be achieved by hydroentanglement of the fibres making up the web. Hydroentanglement is a process whereby fibers of the web are rearranged and entangled by means of fluid forces. Hydroentanglement can in this way be used as a bonding means, repositioning and entangling individual fibers into configurations that bring about frictional interlocking at the fiber level. In addition to the bonding benefits, hydroentanglement can also be used to provide surface texturing, whereby hydroentanglement repositions fibers into open-patterned arrangements.

Laundry Additive

The laundry additive of the of the present invention comprises a dye absorbing agent and/or a dirt absorbing agent. Preferably the laundry additive also comprises a water softening agent. More preferably the laundry additive also comprises other optional laundry additive components.

Dye Absorbing Agent

As discussed above wash items typically loose or give up some dye during the washing process, this even when the item has been washed many times previously. The fugitive dye in the wash water can in some cases redeposit on or reassociate with other wash items, leaving unsightly marks and spots. The dye absorbing agent of the present invention is thus a compound that prevents or at least reduces the ability of the fugitive dyes to redeposit or reassociate with the wash item. In a preferred embodiment the dye absorbing agent irreversibly chemically or physically interacts with the dye, preventing the dye from reassociating with the wash item. The dye absorbing agents are preferably cationic or polar providing a means for interaction with the anionic groups of dyes. The dye absorbing agent is also preferably polymeric.

Dirt Binding Agent

The dirt binding agent is a compound which has an affinity for and binds or interacts with dirt particles. The term ‘Dirt’ as used herein is defined by all undesirable materials deposited on fabrics during wear, and which the washing process is designed to remove. In particular this includes all soils and stains which have a tendency to redeposit onto other parts of the same of other wash items, for example, clay particles, greasy droplets, pigment particles, fugitive dyes and mixtures thereof. In a preferred aspect the dirt binding agent has an irreversible affinity for the dirt particles. The dirt binding agent is believed to work in a similar way to the dye absorbing agent, namely physically or chemically interacting with the dirt, preventing it from reassociating with the wash item.

The dye absorbing and dirt binding agents are preferably insoluble in water, and thus remain within the cavity of the sachet through the entire washing process. Alternatively, and more preferably the dye absorbing and dirt binding agents may be soluble or insoluble in water and are supported by a carrier. The carrier may be any suitable inert and water insoluble support matrix, including an unreactive chemical compound, for example zeolite or a sheet of fabric, for example cotton. Cotton is an especially preferred carrier, since those dye absorbing and/or dirt binding agents which are positively charged can interact with the negatively charged hydroxyl groups on the cotton fiber. Whilst a chemical interaction between the carrier and the dye absorbing and dirt binding agent is not essential, it does permit a stronger affinity for the carrier. Alternatively the dye absorbing and dirt binding agent may simply be loaded onto or incorporated into the carrier by any suitable method for example spraying, painting, pouring etc.

Preferably the dye absorbing agent and the dirt binding agent are selected form the group consisting of ethoxylated cationic diamine, ethoxylated cationic polyamine, ethoxylated cationic amine polymers, polymers/co-polymers of maleic/acrylic acid, polyacrylic-maleic phosphono-end group copolymer, quaternary ammonium-hydroxy-haloalkyl, epoxyalkyl ammonium, polyquaternary ammonium, polyamphoterics, cationic starches, proteins, chitin, chitosan, polyvinyl amine, polyethylene imine, polyethoxylated-quaternized-sulfated amine polyvinylpyrrolidone, polyvinyl pyridine-N-oxide (PVNO), crosslinked PVNO (XL-PVNO), Poly vinyl imidazol, polyvinyl alcohol, polyamine-N-oxide, PVPPVAmine, magnesium aluminate, poly ethylene imines, polyvinyl oxazolidone, cationic surfactants, amphoteric surfactants and mixtures thereof.

Dye absorbing and/or dirt binding agents may also include polyamine polymers for example polyalkoxylated polyamines. Such materials can conveniently be represented as molecules of the empirical structures with repeating units:

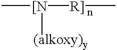

Amine form

and

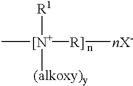

Quaternized form

wherein R is a hydrocarbyl group, usually of 2-6 carbon atoms; R¹ may be a C₁-C₂₀ hydrocarbon; the alkoxy groups are ethoxy, propoxy, and the like, and y is 2-30, most preferably from 10-20; n is an integer of at least 2, preferably from 2-20, most preferably 3-5; and X⁻ is an anion such as halide or methylsulfate, resulting from the quaternization reaction.

The most highly preferred polyamines for use herein are the so-called ethoxylated polyethylene amines, i.e., the polymerized reaction product of ethylene oxide with ethyleneimine, having the general formula:

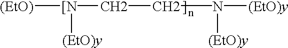

when y=2-30. Particularly preferred for use herein is an ethoxylated polyethylene amine, in particular ethoxylated tetraethylenepentamine, and quaternized ethoxylated hexamethylene diamine.

The dye absorbing and/or dirt binding agents may also include compounds characterised by having both hydrophilic segments and hydrophobic segments. Preferred such compounds are those comprising: (a) one or more nonionic hydrophile components consisting essentially of (i) polyoxyethylene segments with a degree of polymerization of at least 2, or (ii) oxypropylene or polyoxypropylene segments with a degree of polymerization of from 2 to 10, wherein said hydrophile segment does not encompass any oxypropylene unit unless it is bonded to adjacent moieties at each end by ether linkages, or (iii) a mixture of oxyalkylene units comprising oxyethylene and from 1 to about 30 oxypropylene units wherein said mixture contains a sufficient amount of oxyethylene units such that the hydrophile component has hydrophilicity great enough to increase the hydrophilicity of conventional polyester synthetic fiber surfaces upon deposit of the compound on such surface, said hydrophile segments preferably comprising at least about 25% oxyethylene units and more preferably, especially for such components having about 20 to 30 oxypropylene units, at least about 50% oxyethylene units; or (b) one or more hydrophobe components comprising (i) C₃ oxyalkylene terephthalate segments, wherein, if said hydrophobe components also comprise oxyethylene terephthalate, the ratio of oxyethylene terephthalate: C₃ oxyalkylene terephthalate units is about 2:1 or lower, (ii) C₄-C₆ alkylene or oxy C₄-C₆ alkylene segments, or mixtures therein, (iii) poly (vinyl ester) segments, preferably polyvinyl acetate), having a degree of polymerization of at least 2, or (iv) C₁-C₄ alkyl ether or C₄ hydroxyalkyl ether substituents, or mixtures therein, wherein said substituents are present in the form of C₁-C₄ alkyl ether or C₄ hydroxyalkyl ether cellulose derivatives, or mixtures therein, and such cellulose derivatives are amphiphilic, whereby they have a sufficient level of C₁-C₄ alkyl ether and/or C₄ hydroxyalkyl ether units to deposit upon conventional polyester synthetic fiber surfaces and retain a sufficient level of hydroxyls, once adhered to such conventional synthetic fiber surface, to increase fiber surface hydrophilicity, or a combination of (a) and (b).

Typically, the polyoxyethylene segments of (a)(i) will have a degree of polymerization of from about 1 to about 200, although higher levels can be used, preferably from 3 to about 150, more preferably from 6 to about 100. Suitable oxy C₄-C₆ alkylene hydrophobe segments include, but are not limited to, end-caps of polymeric dye absorbing and/or dirt binding agents such as MO₃S(CH₂)ₙOCH₂CH₂O—, where M is sodium and n is an integer from 4-6, as disclosed in U.S. Pat. No. 4,721,580, issued Jan. 26, 1988 to Gosselink.

Other dye absorbing and/or dirt binding agents include cellulosic derivatives such as hydroxyether cellulosic polymers, co-polymeric blocks of ethylene terephthalate or propylene terephthalate with polyethylene oxide or polypropylene oxide terephthalate, and the like. Such agents are commercially available and include hydroxyethers of cellulose such as METHOCEL (Dow). Cellulosic dye absorbing and/or dirt binding agents for use herein also include those selected from the group consisting of C₁-C₄ alkyl and C₄ hydroxyalkyl cellulose; see U.S. Pat. No. 4,000,093, issued Dec. 28, 1976 to Nicol, et al.

Other dye absorbing and/or dirt binding agents characterised by poly(vinyl ester) hydrophobe segments include graft co-polymers of poly(vinyl ester), e.g., C₁-C₆ vinyl esters, preferably poly(vinyl acetate) grafted onto polyalkylene oxide backbones, such as polyethylene oxide backbones may also be included herein. See European Patent Application 0 219 048, published Apr. 22, 1987 by Kud, et al. Commercially available dye absorbing and/or dirt binding agents of this kind include the SOKALAN type of material, e.g., SOKALAN HP-22, available from BASF (West Germany).

One type of preferred dye absorbing and/or dirt binding agents is a co-polymer having random blocks of ethylene terephthalate and polyethylene oxide (PEO) terephthalate. The molecular weight of this polymeric dye absorbing and/or dirt binding agent is in the range of from about 25,000 to about 55,000. See U.S. Pat. No. 3,959,230 to Hays, issued May 25, 1976 and U.S. Pat. No. 3,893,929 to Basadur issued Jul. 8,1975.

Another preferred dye absorbing and/or dirt binding agents is a polyester with repeat units of ethylene terephthalate units which contains 10-15% by weight of ethylene terephthalate units together with 90-80% by weight of polyoxyethylene terephthalate units, derived from a polyoxyethylene glycol of average molecular weight 300-5,000. Examples of this polymer include the commercially available material ZELCON 5126 (from Dupont) and MILEASE T (from ICI). See also U.S. Pat. No. 4,702,857, issued Oct. 27,1987 to Gosselink.

Other dye absorbing and/or dirt binding agents are a sulfonated product of a substantially linear ester oligomer comprised of an oligomeric ester backbone of terephthaloyl and oxyalkyleneoxy repeat units and terminal moieties covalently attached to the backbone. These dye absorbing and/or dirt binding agents are fully described in U.S. Pat. No. 4,968,451, issued Nov. 6, 1990 to J. J. Scheibel and E. P. Gosselink. Other suitable polymeric dye absorbing and/or dirt binding agents include the terephthalate polyesters of U.S. Pat. No. 4,711,730, issued Dec. 8, 1987 to Gosselink et al, the anionic end-capped oligomeric esters of U.S. Pat. No. 4,721,580, issued Jan. 26, 1988 to Gosselink, and the block polyester oligomeric compounds of U.S. Pat. No. 4,702,857, issued Oct. 27,1987 to Gosselink.

Preferred dye absorbing and/or dirt binding agents also include those of U.S. Pat. No. 4,877,896, issued Oct. 31, 1989 to Maldonado et al, which discloses anionic, especially sulfoaroyl, end-capped terephthalate esters.

Still another dye absorbing and/or dirt binding agent is an oligomer with repeat units of terephthaloyl units, sulfoisoterephthaloyl units, oxyethyleneoxy and oxy-1,2-propylene units. The repeat units form the backbone of the oligomer and are preferably terminated with modified isethionate end-caps. A particularly preferred dye absorbing and/or dirt binding agent of this type comprises about one sulfoisophthaloyl unit, 5 terephthaloyl units, oxyethyleneoxy and oxy-1,2-propyleneoxy units in a ratio of from about 1.7 to about 1.8, and two end-cap units of sodium 2-(2-hydroxyethoxy)-ethanesulfonate. Said dye absorbing and/or dirt binding agent also comprises from about 0.5% to about 20%, by weight of the oligomer, of a crystalline-reducing stabilizer, preferably selected from the group consisting of xylene sulfonate, cumene sulfonate, toluene sulfonate, and mixtures thereof. See U.S. Pat. No. 5,415,807, issued May 16, 1995, to Gosselink et al.

Other dye absorbing and/or dirt binding agents include polyvinyl pyrrolidone polymers, polyamine N-oxide polymers, co-polymers of N-vinylpyrrolidone and N-vinylimidazole, manganese phthalocyanine, peroxidases, and mixtures thereof.

More specifically, the polyamine N-oxide polymers preferred for use herein contain units having the following structural formula: R-Aₓ-P; wherein P is a polymerizable unit to which an N—O group can be attached or the N—O group can form part of the polymerizable unit or the N—O group can be attached to both units; A is one of the following structures: —NC(O)—, —C(O)O—, —S—, —O—, —N═; x is 0 or 1; and R is aliphatic, ethoxylated aliphatics, aromatics, heterocyclic or alicyclic groups or any combination thereof to which the nitrogen of the N—O group can be attached or the N—O group is part of these groups. Preferred polyamine N-oxides are those wherein R is a heterocyclic group such as pyridine, pyrrole, imidazole, pyrrolidine, piperidine and derivatives thereof.

The N—O group can be represented by the following general structures:

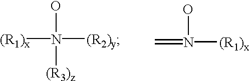

wherein R₁, R₂, R₃ are aliphatic, aromatic, heterocyclic or alicyclic groups or combinations thereof; x, y and z are 0 or 1; and the nitrogen of the N—O group can be attached or form part of any of the aforementioned groups. The amine oxide unit of the polyamine N-oxides has a pKa<10, preferably pKa<7, more preferred pKa<6.

Any polymer backbone can be used as long as the amine oxide polymer formed is water-soluble and has dye transfer inhibiting properties. Examples of suitable polymeric backbones are polyvinyls, polyalkylenes, polyesters, polyethers, polyamide, polyimides, polyacrylates and mixtures thereof. These polymers include random or block co-polymers where one monomer type is an amine N-oxide and the other monomer type is an N-oxide. The amine N-oxide polymers typically have a ratio of amine to the amine N-oxide of 10:1 to 1:1,000,000. However, the number of amine oxide groups present in the polyamine oxide polymer can be varied by appropriate co-polymerization or by an appropriate degree of N-oxidation. The polyamine oxides can be obtained in almost any degree of polymerization. Typically, the average molecular weight is within the range of 500 to 1,000,000; more preferred 1,000 to 500,000; most preferred 5,000 to 100,000. This preferred class of materials can be referred to as “PVNO”. The most preferred polyamine N-oxide useful in the detergent laundry additives herein is poly(4-vinylpyridine-N-oxide) which as an average molecular weight of about 50,000 and an amine to amine N-oxide ratio of about 1:4.

Co-polymers of N-vinylpyrrolidone and N-vinylimidazole polymers (referred to as a class as “PVPVI”) are also preferred for use herein. Preferably the PVPVI has an average molecular weight range from 5,000 to 1,000,000, more preferably from 5,000 to 200,000, and most preferably from 10,000 to 20,000. (The average molecular weight range is determined by light scattering as described in Barth, et al., Chemical Analysis, Vol 113. “Modern Methods of Polymer Characterization”, the disclosures of which are incorporated herein by reference.) The PVPVI co-polymers typically have a molar ratio of N-vinylimidazole to N-vinylpyrrolidone from 1:1 to 0.2:1, more preferably from 0.8:1 to 0.3:1, most preferably from 0.6:1 to 0.4:1. These co-polymers can be either linear or branched.

The present invention laundry additives may also employ a polyvinylpyrrolidone (“PVP”) having an average molecular weight of from 5,000 to 400,000, preferably from 5,000 to 200,000, and more preferably from 5,000 to 50,000. PVP's are known to persons skilled in the detergent field; see, for example, EP-A-262,897 and EP-A-256,696, incorporated herein by reference. Laundry additives containing PVP can also contain polyethylene glycol (“PEG”) having an average molecular weight from 500 to 100,000, preferably from 1,000 to 10,000. Preferably, the ratio of PEG to PVP on a ppm basis delivered in wash solutions is from 2:1 to 50:1, and more preferably from 3:1 to 10:1.

More preferably the dye absorbing agent is selected from the group consisting of XL-PVNO, Tinofix FRD, a fabric enhancer commercially available from CIBA (unknown formula) and mixtures thereof.

More preferably the dirt binding agent is selected form the group consisting of XL-PVNO, acrylic acid/maleic acid copolymers having molecular weight between 1000 and 1.000.000 or a X-linked polycarboxylic polymer, preferably a cross linked polyacrylate polymer such as those sold under the tradename of Carbopol from BF, ethoxylated cationic diamine and mixtures thereof.

However it is also possible that the dye absorbing agent and the dirt binding agent is a single compound that performs both functions.

The dye absorbing agent provides an additional benefit as a visual indicator of the effectiveness of fugitive dye scavenging, by a change in colour owing to the absorption of the dye. The user is therefore assured not only of the effectiveness of the sachet, but also of the presence of fugitive dyes and that redeposition or reassociation of those dyes did not take place on the wash items. The sachet is thus preferably either translucent or comprises a network consisting of fibres separated by holes, through which the user can see the dye absorbing and/or dirt binding agents inside the cavity of the sachet, and the colour change provided thereto.

Dye absorbing and/or dirt binding agents are preferably present at a level of from 0.01% to 10% by weight of the laundry additive, more preferably from 0.01% to 5%, and most preferably from 0.05% to 2%.

Water Softening Agent

In a preferred embodiment of the present invention, the laundry additive also comprises a water softening agent. The water softening agent removes hardness ions from the wash water thereby improving whiteness of the fabric and cleaning performance of the laundry additive.

The water softening agent is preferably selected from the group consisting of ion exchange resin, builders, anti-encrustation agents and mixtures thereof.

Suitable ion exchange resins herein are either weak or strong, cation exchange resins.

By “weak ion exchange resin” it is meant herein, a resin which has weak acid or base functional groups attached to the polymeric matrix. A weak acid group is characterized in that its pKₐ is higher than 2.5. A weak base is characterized in that its pK_{b} is higher than 2.5.

By “strong ion exchange resin” it is meant herein, a resin which has strong acid or base functional groups attached to the polymeric matrix. A strong acid group is characterized in that its pKₐ is lower than 2.5. A strong base is characterized in that its pK_{b} is lower than 2.5.

Suitable weak cation exchange resins herein are selected from the group consisting of resins having carboxylic acid groups as the functional groups and mixtures thereof. A preferred weak cation exchange resin is a copolymer of methacrylic acid and divinylbenzene in the form of its potassium salt, commercially available under the trade name of Amberlite IRP-88® from Polyscience Inc.

Suitable strong cation exchange resins herein are selected from the group consisting of resins having sulphonic acid groups as the functional groups and mixtures thereof.

Furthermore, the ion exchange resin may be either crosslinked or non-crosslinked.

Preferably, the ion exchange resins herein are water-insoluble, water-swellable polymers.

In a preferred embodiment according to the present invention, the ion exchange resin is a cation exchange resin. More preferably, the ion exchange resin is a strong cation exchange resin. Even more preferably, said cation exchange resin is selected from the group consisting of sulfonated polystyrene resins and acrylic or methacrylic resins and mixtures thereof. Most preferably, the ion exchange resin herein is a crosslinked polystyrene sulphonate resin.

Suitable crosslinked polystyrene sulphonate resins are commercially available under the trade name PG2000-Na® from Purolite.

Builders according to the present invention include inorganic as well as organic builders. Inorganic or P-containing detergent builders include, but are not limited to, the alkali metal, ammonium and alkanolammonium salts of polyphosphates (exemplified by the tripolyphosphates, pyrophosphates, and glassy polymeric meta-phosphates), phosphonates, phytic acid, silicates, carbonates (including bicarbonates and sesquicarbonates), sulphates, and aluminosilicates. However, non-phosphate builders are required in some locales.

Examples of silicate builders are the alkali metal silicates, particularly those having a SiO₂:Na₂O ratio in the range 1.6:1 to 3.2:1 and layered silicates, such as the layered sodium silicates described in U.S. Pat. No. 4,664,839, issued May 12, 1987 to H. P. Rieck. NaSKS-6® is the trademark for a crystalline layered silicate marketed by Hoechst (commonly abbreviated herein as “SKS-6”). Unlike zeolite builders, the Na SKS-6 silicate builder does not contain aluminum. NaSKS-6® has the delta-Na₂SiO₅ morphology form of layered silicate. It can be prepared by methods such as those described in German DE-A-3,417,649 and DE-A-3,742,043. SKS-6 is a highly preferred layered silicate for use herein, but other such layered silicates, such as those having the general formula NaMSixO₂x+1.yH₂O wherein M is sodium or hydrogen, x is a number from 1.9 to 4, preferably 2, and y is a number from 0 to 20, preferably 0 can be used herein. Various other layered silicates from Hoechst include NaSKS-5, NaSKS-7 and NaSKS-11, as the alpha, beta and gamma forms. As noted above, the delta-Na₂SiO₅ (NaSKS-6) is most preferred for use herein. Other silicates may also be useful such as for example magnesium silicate, which can serve as a crispening agent in granular formulations, as a stabilizing agent for oxygen bleaches, and as a component of suds control systems.

Examples of carbonate builders are the alkaline earth and alkali metal carbonates as disclosed in German Patent Application No. 2,321,001 published on Nov. 15,1973.

Aluminosilicate builders are useful in the present invention. Aluminosilicate builders are of great importance in most currently marketed heavy duty granular detergent laundry additives, and can also be a significant builder ingredient in liquid detergent formulations. Aluminosilicate builders include those having the empirical formula:

Mz(zAIO₂)y].xH₂O

wherein z and y are integers of at least 6, the molar ratio of z to y is in the range from 1.0 to about 0.5, and x is an integer from about 15 to about 264.

Useful aluminosilicate ion exchange materials are commercially available. These aluminosilicates can be crystalline or amorphous in structure and can be naturally-occurring aluminosilicates or synthetically derived. A method for producing aluminosilicate ion exchange materials is disclosed in U.S. Pat. No. 3,985,669, Krummel, et al, issued Oct. 12, 1976. Preferred synthetic crystalline aluminosilicate ion exchange materials useful herein are available under the designations Zeolite A, Zeolite P (B), Zeolite MAP and Zeolite X. In an especially preferred embodiment, the crystalline aluminosilicate ion exchange material has the formula:

Na₁₂[(AIO₂)₁₂(SiO₂)₁₂].xH₂O

wherein x is from about 20 to about 30, especially about 27. This material is known as Zeolite A. Dehydrated zeolites (x=0-10) may also be used herein. Preferably, the aluminosilicate has a particle size of about 0.1-10 microns in diameter.

Organic detergent builders preferred for the purposes of the present invention include, but are not restricted to, a wide variety of polycarboxylate compounds. As used herein, “polycarboxylate” refers to compounds having a plurality of carboxylate groups, preferably at least 3 carboxylates. Polycarboxylate builder can generally be added to the laundry additive in acid form, but can also be added in the form of a neutralized salt. When utilized in salt form, alkali metals, such as sodium, potassium, and lithium, or alkanolammonium salts are preferred.

Included among the polycarboxylate builders are a variety of categories of useful materials. One important category of polycarboxylate builders encompasses the ether polycarboxylates, including oxydisuccinate, as disclosed in Berg, U.S. Pat. No. 3,128,287, issued Apr. 7, 1964, and Lamberti et al., U.S. Pat. No. 3,635,830, issued Jan. 18, 1972. See also “TMS/TDS” builders of U.S. Pat. No. 4,663,071, issued to Bush et al., on May 5, 1987. Suitable ether polycarboxylates also include cyclic compounds, particularly alicyclic compounds, such as those described in U.S. Pat. Nos. 3,923,679; 3,835,163; 4,158,635; 4,120,874 and 4,102,903.

Other useful detergency builders include the ether hydroxypolycarboxylates, copolymers of maleic anhydride with ethylene or vinyl methyl ether, 1, 3, 5-trihydroxy benzene-2, 4, 6-trisulphonic acid, and carboxymethyloxysuccinic acid, the various alkali metal, ammonium and substituted ammonium salts of polyacetic acids such as ethylenediamine tetraacetic acid and nitrilotriacetic acid, as well as polycarboxylates such as mellitic acid, succinic acid, oxydisuccinic acid, polymaleic acid, benzene 1,3,5-tricarboxylic acid, carboxymethyloxysuccinic acid, and soluble salts thereof.

Citrate builders, e.g., citric acid and soluble salts thereof (particularly sodium salt), are polycarboxylate builders of particular importance for heavy duty liquid detergent formulations due to their availability from renewable resources and their biodegradability. Citrates can also be used in granular laundry additives, especially in combination with zeolite and/or layered silicate builders. Oxydisuccinates are also especially useful in such laundry additives and combinations.

Also suitable are the 3,3-dicarboxy-4-oxa-1,6-hexanedioates and the related compounds disclosed in U.S. Pat. No. 4,566,984, Bush, issued Jan. 28, 1986. Useful succinic acid builders include the C5-C20 alkyl and alkenyl succinic acids and salts thereof. A particularly preferred compound of this type is dodecenylsuccinic acid. Specific examples of succinate builders include: laurylsuccinate, myristylsuccinate, palmitylsuccinate, 2-dodecenylsuccinate (preferred), 2-pentadecenylsuccinate, and the like. Laurylsuccinates are the preferred builders of this group, and are described in European Patent Application 86200690.5/0,200,263, published Nov. 5,1986.

Other suitable polycarboxylates are disclosed in U.S. Pat. No. 4,144,226, Crutchfield et al., issued Mar. 13, 1979, and in U.S. Pat. No. 3,308,067, Diehl, issued Mar. 7,1967. See also Diehl U.S. Pat. No. 3,723,322.

Fatty acids, e.g., C12-C18 monocarboxylic acids, can also be incorporated into the laundry additives alone, or in combination with the aforesaid builders, especially citrate and/or the succinate builders, to provide additional builder activity.

In situations where phosphorus-based builders can be used, the various alkali metal phosphates such as the well-known sodium tripolyphosphates, sodium pyrophosphate and sodium orthophosphate can be used. Phosphonate builders such as ethane-1-hydroxy-1,1-diphosphonate and other known phosphonates (see, for example, U.S. Pat. Nos. 3,159,581; 3,213,030; 3,422,021; 3,400,148 and 3,422,137) can also be used.

Anti-Encrustation Agents are defined as components which reduce or prevent the formation of calcium carbonate crystals, preferably by inhibiting the formation of the most stable crystalline phase of calcium carbonate. Preferred anti-encrustation agents include organo diphosphonic acid components, incorporated preferably at a level of from 0.01% to 50%, more preferably from 0.1% to 10% by weight of the laundry additive.

By organo diphosphonic acid it is meant herein an organo diphosphonic acid which does not contain nitrogen as part of its chemical structure. His definition therefore excludes the organo aminophosphonates, which however may be included in compositions of the invention as chelating agents.

The organo diphosphonic acid is preferably a C₁-C₄ diphosphonic acid, more preferably a C₂ diphosphonic acid, such as ethylene diphosphonic acid, or most preferably ethane 1-hydroxy-1,1-diphosphonic acid (HEDP) and may be present in partially or fully ionized form, particularly as a salt or complex.

Other Optional Components

The laundry additive may also comprise other conventional laundry additive components including bleaching agents, bleach activators and catalysts, surfactants, enzymes, chelating agents, disinfecting agents, brighteners, suds boosters, suds suppressors, perfumes and mixtures thereof.

Surfactant

The laundry additive of the present invention may optionally comprise a surfactant. The surfactants are selected from the group consisting of nonionic surfactants, anionic surfactants, cationic surfactants, zwitterionic surfactants and/or amphoteric surfactants.

Suitable anionic surfactants include water-soluble salts or acids of the formula ROSO₃M wherein R preferably is a C₁₀-C₂₄ hydrocarbyl, preferably an alkyl or hydroxyalkyl having a C₁₀-C₂₀ alkyl component, more preferably a C₁₂-C₁₈ alkyl or hydroxyalkyl, and M is H or a cation, e.g., an alkali metal cation (e.g., sodium, potassium, lithium), or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like). Typically, alkyl chains of C₁₂-₁₆ are preferred for lower wash temperatures (e.g., below about 50° C.) and C₁₆-₁₈ alkyl chains are preferred for higher wash temperatures (e.g., above about 50° C.).

Other suitable anionic surfactants for use herein are water-soluble salts or acids of the formula RO(A)ₘSO₃M wherein R is an unsubstituted C₁₀-C₂₄ alkyl or hydroxyalkyl group having a C₁₀-C₂₄ alkyl component, preferably a C₁₂-C₂₀ alkyl or hydroxyalkyl, more preferably C₁₂-C₁₈ alkyl or hydroxyalkyl, A is an ethoxy or propoxy unit, m is greater than zero, typically between about 0.5 and about 6, more preferably between about 0.5 and about 3, and M is H or a cation which can be, for example, a metal cation (e.g., sodium, potassium, lithium, calcium, magnesium, etc.), ammonium or substituted-ammonium cation. Alkyl ethoxylated sulfates as well as alkyl propoxylated sulfates are contemplated herein. Specific examples of substituted ammonium cations include methyl-, dimethyl-, trimethyl-ammonium and quaternary ammonium cations, such as tetramethyl-ammonium, dimethyl piperdinium and cations derived from alkanolamines such as ethylamine, diethylamine, triethylamine, mixtures thereof, and the like. Exemplary surfactants are C₁₂-C₁₈ alkyl polyethoxylate (1.0) sulfate, C₁₂-C₁₈E(1.0)M), C₁₂-C₁₈ alkyl polyethoxylate (2.25) sulfate, C₁₂-C₁₈E(2.25)M), C₁₂-C₁₈ alkyl polyethoxylate (3.0) sulfate C₁₂-C₁₈E(3.0), and C₁₂-C₁₈ alkyl polyethoxylate (4.0) sulfate C₁₂-C₁₈E(4.0)M), wherein M is conveniently selected from sodium and potassium.

Other particularly suitable anionic surfactants for use herein are alkyl sulphonates including water-soluble salts or acids of the formula RSO₃M wherein R is a C₆-C₂₂ linear or branched, saturated or unsaturated alkyl group, preferably a C₁₂-C₁₈ alkyl group and more preferably a C₁₄-C₁₆ alkyl group, and M is H or a cation, e.g., an alkali metal cation (e.g., sodium, potassium, lithium), or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like).

Suitable alkyl aryl sulphonates for use herein include water-soluble salts or acids of the formula RSO₃M wherein R is an aryl, preferably a benzyl, substituted by a C₆-C₂₂ linear or branched saturated or unsaturated alkyl group, preferably a C₁₂-C₁₈ alkyl group and more preferably a C₁₄-C₁₆ alkyl group, and M is H or a cation, e.g., an alkali metal cation (e.g., sodium, potassium, lithium, calcium, magnesium etc) or ammonium or substituted ammonium (e.g., methyl-, dimethyl-,and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like).

The alkylsulfonates and alkyl aryl sulphonates for use herein include primary and secondary alkylsulfonates and primary and secondary alkyl aryl sulphonates. By “secondary C6-C22 alkyl or C6-C22 alkyl aryl sulphonates”, it is meant herein that in the formula as defined above, the SO3M or aryl-SO3M group is linked to a carbon atom of the alkyl chain being placed between two other carbons of the said alkyl chain (secondary carbon atom).

For example C14-C16 alkyl sulphonate salt is commercially available under the name Hostapur ® SAS from Hoechst and C8-alkylsulphonate sodium salt is commercially available under the name Witconate NAS 8® from Witco SA. An example of commercially available alkyl aryl sulphonate is Lauryl aryl sulphonate from Su.Ma. Particularly preferred alkyl aryl sulphonates are alkyl benzene sulphonates commercially available under trade name Nansa® available from Albright & Wilson.

Other anionic surfactants useful for detersive purposes can also be used herein. These can include salts (including, for example, sodium, potassium, ammonium, and substituted ammonium salts such as mono-, di- and triethanolamine salts) of soap, C₈-C₂₄ olefinsulfonates, sulfonated polycarboxylic acids prepared by sulfonation of the pyrolyzed product of alkaline earth metal citrates, e.g., as described in British patent specification No. 1,082,179, C₈-C₂₄ alkylpolyglycolethersulfates (containing up to 10 moles of ethylene oxide); alkyl ester sulfonates such as C₁₄-₁₆ methyl ester sulfonates; acyl glycerol sulfonates, fatty oleyl glycerol sulfates, alkyl phenol ethylene oxide ether sulfates, paraffin sulfonates, alkyl phosphates, isethionates such as the acyl isethionates, N-acyl taurates, alkyl succinamates and sulfosuccinates, monoesters of sulfosuccinate (especially saturated and unsaturated C₁₂-C₁₈ monoesters) diesters of sulfosuccinate (especially saturated and unsaturated C₆-C₁₄ diesters), sulfates of alkylpolysaccharides such as the sulfates of alkylpolyglucoside (the nonionic nonsulfated compounds being described below), branched primary alkyl sulfates, alkyl polyethoxy carboxylates such as those of the formula RO(CH₂CH₂O)ₖCH₂COO-M⁺ wherein R is a C₈-C₂₂ alkyl, k is an integer from 0 to 10, and M is a soluble salt-forming cation. Resin acids and hydrogenated resin acids are also suitable, such as rosin, hydrogenated rosin, and resin acids and hydrogenated resin acids present in or derived from tall oil. Further examples are given in “Surface Active Agents and Detergents” (Vol. I and II by Schwartz, Perry and Berch). A variety of such surfactants are also generally disclosed in U.S. Pat. No. 3,929,678, issued Dec. 30, 1975, to Laughlin, et al. at Column 23, line 58 through Column 29, line 23 (herein incorporated by reference).

Other particularly suitable anionic surfactants for use herein are alkyl carboxylates and alkyl alkoxycarboxylates having from 4 to 24 carbon atoms in the alkyl chain, preferably from 8 to 18 and more preferably from 8 to 16, wherein the alkoxy is propoxy and/or ethoxy and preferably is ethoxy at an alkoxylation degree of from 0.5 to 20, preferably from 5 to 15. Preferred alkylalkoxycarboxylate for use herein is sodium laureth 11 carboxylate (i.e., RO(C₂H₄O)₁₀-CH₂COONa, with R═C12-C14) commercially available under the name Akyposoft® 100NV from Kao Chemical Gbmh.

Suitable amphoteric surfactants for use herein include amine oxides having the following formula R₁ R₂R₃NO wherein each of R1, R2 and R3 is independently a saturated substituted or unsubstituted, linear or branched hydrocarbon chain of from 1 to 30 carbon atoms. Preferred amine oxide surfactants to be used according to the present invention are amine oxides having the following formula R₁ R₂R₃NO wherein R1 is an hydrocarbon chain comprising from 1 to 30 carbon atoms, preferably from 6 to 20, more preferably from 8 to 16, most preferably from 8 to 12, and wherein R2 and R3 are independently substituted or unsubstituted, linear or branched hydrocarbon chains comprising from 1 to 4 carbon atoms, preferably from 1 to 3 carbon atoms, and more preferably are methyl groups. R¹ may be a saturated, substituted or unsubstituted linear or branched hydrocarbon chain. Suitable amine oxides for use herein are for instance natural blend C8-C10 amine oxides as well as C12-C16 amine oxides commercially available from Hoechst.

Suitable zwitterionic surfactants for use herein contain both a cationic hydrophilic group, i.e., a quaternary ammonium group, and anionic hydrophilic group on the same molecule at a relatively wide range of pH's. The typical anionic hydrophilic groups are carboxylates and sulfonates, although other groups like sulfates, phosphonates, and the like can be used. A generic formula for the zwitterionic surfactants to be used herein is:

R₁-N⁺(R₂)(R₃)R₄X⁻

wherein R₁ is a hydrophobic group; R₂ is hydrogen, C₁-C₆ alkyl, hydroxy alkyl or other substituted C₁-C₆ alkyl group; R₃ is C₁-C₆ alkyl, hydroxy alkyl or other substituted C₁-C₆ alkyl group which can also be joined to R₂ to form ring structures with the N, or a C₁-C₆ carboxylic acid group or a C₁-C₆ sulfonate group; R₄ is a moiety joining the cationic nitrogen atom to the hydrophilic group and is typically an alkylene, hydroxy alkylene, or polyalkoxy group containing from 1 to 10 carbon atoms; and X is the hydrophilic group which is a carboxylate or sulfonate group.

Preferred hydrophobic groups R₁ are aliphatic or aromatic, saturated or unsaturated, substituted or unsubstituted hydrocarbon chains that can contain linking groups such as amido groups, ester groups. More preferred R₁ is an alkyl group containing from 1 to 24 carbon atoms, preferably from 8 to 18, and more preferably from 10 to 16. These simple alkyl groups are preferred for cost and stability reasons. However, the hydrophobic group R₁ can also be an amido radical of the formula Rₐ—C(O)—NH—(C(R_{b})2)ₘ, wherein Rₐ is an aliphatic or aromatic, saturated or unsaturated, substituted or unsubstituted hydrocarbon chain, preferably an alkyl group containing from 8 up to 20 carbon atoms, preferably up to 18, more preferably up to 16, R_{b} is selected from the group consisting of hydrogen and hydroxy groups, and m is from 1 to 4, preferably from 2 to 3, more preferably 3, with no more than one hydroxy group in any (C(R_{b})₂) moiety.

Preferred R₂ is hydrogen, or a C₁-C₃ alkyl and more preferably methyl. Preferred R₃ is a C₁-C₄ carboxylic acid group or C₁-C₄ sulfonate group, or a C₁-C₃ alkyl and more preferably methyl. Preferred R₄ is (CH2)ₙ wherein n is an integer from 1 to 10, preferably from 1 to 6, more preferably is from 1 to 3.

Some common examples of betaine/sulphobetaine are described in U.S. Pat. Nos. 2,082,275, 2,702,279 and 2,255,082, incorporated herein by reference.

Examples of particularly suitable alkyidimethyl betaines include coconut-dimethyl betaine, lauryl dimethyl betaine, decyl dimethyl betaine, 2-(N-decyl-N, N-dimethyl-ammonia)acetate, 2-(N-coco N, N-dimethylammonio) acetate, myristyl dimethyl betaine, palmityl dimethyl betaine, cetyl dimethyl betaine, stearyl dimethyl betaine. For example Coconut dimethyl betaine is commercially available from Seppic under the trade name of Amonyl 265®. Lauryl betaine is commercially available from Albright & Wilson under the trade name Empigen BB/L®.

Examples of amidobetaines include cocoamidoethylbetaine, cocoamidopropyl betaine or C10-C14 fatty acylamidopropylene(hydropropylene)sulfobetaine. For example C10-C14 fatty acylamidopropylene(hydropropylene)sulfobetaine is commercially available from Sherex Company under the trade name “Varion CAS® sulfobetaine”.

A further example of betaine is Lauryl-imino-dipropionate commercially available from Rhone-Poulenc under the trade name Mirataine H2C-HA ®.

Suitable cationic surfactants for use herein include derivatives of quaternary ammonium, phosphonium, imidazolium and sulfonium compounds. Preferred cationic surfactants for use herein are quaternary ammonium compounds wherein one or two of the hydrocarbon groups linked to nitrogen are a saturated, linear or branched alkyl group of 6 to 30 carbon atoms, preferably of 10 to 25 carbon atoms, and more preferably of 12 to 20 carbon atoms, and wherein the other hydrocarbon groups (i.e. three when one hydrocarbon group is a long chain hydrocarbon group as mentioned hereinbefore or two when two hydrocarbon groups are long chain hydrocarbon groups as mentioned hereinbefore) linked to the nitrogen are independently substituted or unsubstituted, linear or branched, alkyl chain of from 1 to 4 carbon atoms, preferably of from 1 to 3 carbon atoms, and more preferably are methyl groups. Preferred quaternary ammonium compounds suitable for use herein are non-chloride/non halogen quaternary ammonium compounds. The counterion used in said quaternary ammonium compounds are compatible with any peracid and are selected from the group of methyl sulfate, or methylsulfonate, and the like. Preferred are trimethyl quaternary ammonium compounds like myristyl trimethylsulfate, cetyl trimethylsulfate and/or tallow trimethylsulfate. Such trimethyl quaternary ammonium compounds are commercially available from Hoechst, or from Albright & Wilson under the trade name EMPIGEN CM®.

Amongst the nonionic surfactants, alkoxylated nonionic surfactants and especially ethoxylated nonionic surfactants are suitable for use herein.

Suitable capped alkoxylated nonionic surfactants for use herein are according to the formula:

R₁ (O—CH₂—CH₂)ₙ—(OR₂)ₘ—O—R₃

wherein R₁ is a C₈-C₂₄ linear or branched alkyl or alkenyl group, aryl group, alkaryl group, preferably R₁ is a C₈-C₁₈ alkyl or alkenyl group, more preferably a C₁₀-C₁₅ alkyl or alkenyl group, even more preferably a C₁₀-C₁₅ alkyl group; wherein R₂ is a C₁-C₁₀ linear or branched alkyl group, preferably a C₂-C₁₀ linear or branched alkyl group; wherein R₃ is a C₁-C₁₀ alkyl or alkenyl group, preferably a C₁-C₅ alkyl group, more preferably methyl; and wherein n and m are integers independently ranging in the range of from 1 to 20, preferably from 1 to 10, more preferably from 1 to 5; or mixtures thereof.

These surfactants are commercially available from BASF under the trade name Plurafac®, from HOECHST under the trade name Genapol® or from ICI under the trade name Symperonic®. Preferred capped nonionic alkoxylated surfactants of the above formula are those commercially available under the tradename Genapol® L 2.5 NR from Hoechst, and Plurafac® from BASF.

Particularly preferred surfactants are those selected from the group consisting of alkyl sulphate, alkyl sulphonate, alkyl ethoxy sulphate, alkyl benzene sulphonate, alkyl carboxylate, alkyl ethoxy carboxylate, amine oxides and mixtures thereof. More preferably the surfactant system comprises an alkyl sulphonate and an amine oxide.

Typically, the laundry additives according to the present invention preferably comprise the surfactant system at a level of from 0.01% to 30%, preferably from 0.1% to 15% and more preferably less than 10% and most preferably from 0.2% to 5% by weight of the laundry additive.

Optical Brightener

The laundry additive may optionally comprise an optical brightener. Where present the brightener is present at a level of from 0.005% to 5%, more preferably from 0.01% to 1%, most preferably from 0.01% to 0.5%. The optical brighteners suitable for use in the present invention are substantially insoluble in water. Wherein substantially insoluble means that less than 1 gram of the brightener will dissolve in 1 liter of distilled water at pH 7. Nonionic brighteners, meaning those brighteners that do not have any permanently charged group or a group selected from sulphonic, sulphate, carboxylic, phosphonate, phosphate and quaternary ammonium.

In a preferred embodiment, the optical brightener is a substantially insoluble compound selected from compounds comprising stilbene, pyrazoline, coumarin, carboxylic acids, methinecyanines, dibenzothiophene-5,5-dioxide, azoles, 5-and 6-membered-ring heterocyclic, benzene or derivatives thereof and mixtures thereof. More preferably the brightener comprises a benzoxozol, pyrazole, triazole, triazine, imidazole, furan group or mixtures thereof.

Examples of preferred commerically available optical brighteners include those selected from the group consisting of Benzoxazole, 2,2′(2,5-thiophenediyl) bis-(7CI, 8CI, 9CI) sold under the tradename Tinopal SOP (from Ciba-Geigy, C.I. Fluorescent Brightener 140 (9CI), 7-(dimethylamino)-4-methyl-2H-1 -benzopyran-2-one (9CI) sold under the tradename Tinopal SWN (from Ciba-Geigy), Benzoxazole, 2,2′(1,2-ethenediyl)bis[5-methyl-(9CI) sold under the tradename Tinopal K (from Ciba-Geigy), C.I. Fluorescent Brightener 352 (9CI) 1 H-Benzimidazole, 2,2′(2,5-furandiyl)bis[1-methyl-(9CI) sold under the tradename Uvitex AT (from Ciba-Geigy).

Chelating agents

The laundry additive may comprise a chelating agent as a preferred optional ingredient. Suitable chelating agents may be any of those known to those skilled in the art such as the ones selected from the group comprising phosphonate chelating agents, amino carboxylate chelating agents, other carboxylate chelating agents, polyfunctionally-substituted aromatic chelating agents, ethylenediamine N,N′-disuccinic acids, or mixtures thereof.

Suitable phosphonate chelating agents for use herein may include alkali metal ethane 1-hydroxy diphosphonates (HEDP), alkylene poly (alkylene phosphonate), as well as amino phosphonate compounds, including amino aminotri(methylene phosphonic acid) (ATMP), nitrilo trimethylene phosphonates (NTP), ethylene diamine tetra methylene phosphonates, and diethylene triamine penta methylene phosphonates (DTPMP). The phosphonate compounds may be present either in their acid form or as salts of different cations on some or all of their acid functionalities. Preferred phosphonate chelating agents to be used herein are diethylene triamine penta methylene phosphonate (DTPMP) and ethane 1-hydroxy diphosphonate (HEDP). Such phosphonate chelating agents are commercially available from Monsanto under the trade name DEQUEST®.

Polyfunctionally-substituted aromatic chelating agents may also be useful in the laundry additives herein. See U.S. Pat. No. 3,812,044, issued May 21, 1974, to Connor et al. Preferred compounds of this type in acid form are dihydroxydisulfobenzenes such as 1,2-dihydroxy -3,5-disulfobenzene.

A preferred biodegradable chelating agent for use herein is ethylene diamine N,N′-disuccinic acid, or alkali metal, or alkaline earth, ammonium or substitutes ammonium salts thereof or mixtures thereof. Ethylenediamine N,N′-disuccinic acids, especially the (S,S) isomer have been extensively described in U.S. Pat. No. 4, 704, 233, Nov. 3, 1987, to Hartman and Perkins. Ethylenediamine N,N ′-disuccinic acids is, for instance, commercially available under the tradename ssEDDS® from Palmer Research Laboratories.

Suitable amino carboxylates to be used herein include ethylene diamine tetra acetates, diethylene triamine pentaacetates, diethylene triamine pentaacetate (DTPA),N-hydroxyethylethylenediamine triacetates, nitrilotri-acetates, ethylenediamine tetrapropionates, triethylenetetraaminehexa-acetates, ethanol-diglycines, propylene diamine tetracetic acid (PDTA) and methyl glycine di-acetic acid (MGDA), both in their acid form, or in their alkali metal, ammonium, and substituted ammonium salt forms. Particularly suitable amino carboxylates to be used herein are diethylene triamine penta acetic acid, propylene diamine tetracetic acid (PDTA) which is, for instance, commercially available from BASF under the trade name Trilon FS® and methyl glycine di-acetic acid (MGDA).

Further carboxylate chelating agents to be used herein include salicylic acid, aspartic acid, glutamic acid, glycine, malonic acid or mixtures thereof.

Another chelating agent for use herein is of the formula:

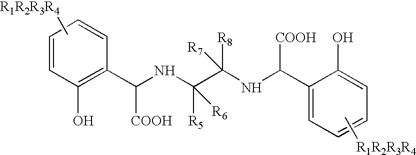

wherein R₁, R₂, R₃, and R₄ are independently selected from the group consisting of —H, alkyl, alkoxy, aryl, aryloxy, —Cl, —Br, —NO₂, —C(O)R′, and —SO₂R″: wherein R′ is selected from the group consisting of —H, —OH, alkyl, alkoxy, aryl, and aryloxy; R″ is selected from the group consisting of alkyl, alkoxy, aryl, and aryloxy; and R₅, R₆, R₇, and R₈ are independently selected from the group consisting of —H and alkyl.

Particularly preferred chelating agents to be used herein are amino aminotri(methylene phosphonic acid), di-ethylene-triamino-pentaacetic acid, diethylene triamine penta methylene phosphonate, 1-hydroxy ethane diphosphonate, ethylenediamine N, N′-disuccinic acid, and mixtures thereof.

Typically, the laundry additives according to the present invention may comprise up to 5% by weight of the total laundry additive of a chelating agent, or mixtures thereof, preferably from 0.01% to 1.5% by weight and more preferably from 0.01% to 0.5%.

Radical scavengers

The laundry additives of the present invention may comprise a radical scavenger or a mixture thereof. Suitable radical scavengers for use herein include the well-known substituted mono and dihydroxy benzenes and their analogs, alkyl and aryl carboxylates and mixtures thereof. Preferred such radical scavengers for use herein include di-tert-butyl hydroxy toluene (BHT), hydroquinone, di-tert-butyl hydroquinone, mono-tert-butyl hydroquinone, tert-butyl-hydroxy anysole, benzoic acid, toluic acid, catechol, t-butyl catechol, benzylamine, 1,1,3-tris(2-methyl-4-hydroxy-5-t-butylphenyl) butane, n-propyl-gallate or mixtures thereof and highly preferred is di-tert-butyl hydroxy toluene. Such radical scavengers like N-propyl-gallate may be commercially available from Nipa Laboratories under the trade name Nipanox S1 ®.

Radical scavengers when used, are typically present herein in amounts up to 10% by weight of the total laundry additive and preferably from 0.001% to 0.5% by weight.

Suds controlling agents

The laundry additives according to the present invention may further comprise a suds controlling agent such as 2-alkyl alkanol, or mixtures thereof, as a preferred optional ingredient. Particularly suitable to be used in the present invention are the 2-alkyl alkanols having an alkyl chain comprising from 6 to 16 carbon atoms, preferably from 8 to 12 and a terminal hydroxy group, said alkyl chain being substituted in the α position by an alkyl chain comprising from 1 to 10 carbon atoms, preferably from 2 to 8 and more preferably 3 to 6. Such suitable compounds are commercially available, for instance, in the Isofol® series such as Isofol® 12 (2-butyl octanol) or Isofol®16 (2-hexyl decanol).

Other suds controlling agents may include alkali metal (e.g., sodium or potassium) fatty acids, or soaps thereof, containing from about 8 to about 24, preferably from about 10 to about 20 carbon atoms.

The fatty acids including those used in making the soaps can be obtained from natural sources such as, for instance, plant or animal-derived glycerides (e.g., palm oil, coconut oil, babassu oil, soybean oil, castor oil, tallow, whale oil, fish oil, tallow, grease, lard and mixtures thereof). The fatty acids can also be synthetically prepared (e.g., by oxidation of petroleum stocks or by the Fischer-Tropsch process).

Alkali metal soaps can be made by direct saponification of fats and oils or by the neutralization of the free fatty acids which are prepared in a separate manufacturing process. Particularly useful are the sodium and potassium salts of the mixtures of fatty acids derived from coconut oil and tallow, i.e., sodium and potassium tallow and coconut soaps.

The term “tallow” is used herein in connection with fatty acid mixtures which typically have an approximate carbon chain length distribution of 2.5% C14, 29% C16, 23% C18, 2% palmitoleic, 41.5% oleic and 3% linoleic (the first three fatty acids listed are saturated). Other mixtures with similar distribution, such as the fatty acids derived from various animal tallows and lard, are also included within the term tallow. The tallow can also be hardened (i.e., hydrogenated) to convert part or all of the unsaturated fatty acid moieties to saturated fatty acid moieties.

When the term “coconut” is used herein it refers to fatty acid mixtures which typically have an approximate carbon chain length distribution of about 8% C8, 7% C10, 48% C12, 17% C14, 9% C16, 2% C18, 7% oleic, and 2% linoleic (the first six fatty acids listed being saturated). Other sources having similar carbon chain length distribution such as palm kernel oil and babassu oil are included with the term coconut oil.

Other suitable suds controlling agents are exemplified by silicones, and silica-silicone mixtures. Silicones can be generally represented by alkylated polysiloxane materials while silica is normally used in finely divided forms exemplified by silica aerogels and xerogels and hydrophobic silicas of various types. These materials can be incorporated as particulates in which the suds controlling agent is advantageously releasable incorporated in a water-soluble or water-dispersible, substantially non-surface-active detergent impermeable carrier. Alternatively the suds controlling agent can be dissolved or dispersed in a liquid carrier and applied by spraying on to one or more of the other components.

A preferred silicone suds controlling agent is disclosed in Bartollota et al. U.S.

Pat. No. 3 933 672. Other particularly useful suds controlling agents are the self-emulsifying silicone suds controlling agents, described in German Patent Application DTOS 2 646 126 published Apr. 28, 1977. An example of such a compound is DC-544, commercially available from Dow Corning, which is a siloxane-glycol copolymer.

Especially preferred silicone suds controlling agents are described in Copending European Patent application No. 92201649.8. Said laundry additives can comprise a silicone/silica mixture in combination with fumed nonporous silica such as Aerosil^{R}.

A preferred type of suds controlling agent is an alkyl capped alcohol alkoxylate. The alkyl chain of the alcohol can be from C3-C30, the alkoxylate is preferably ethoxylate comprising preferably from 1 to 30 moles thereof and the cap is preferably a C1-C6 linear or branched alkyl group.

Especially preferred suds controlling agent are the suds controlling agent system comprising a mixture of silicone oils and the 2-alkyl-alcanols.

Typically, the laundry additives herein may comprise up to 4% by weight of the total laundry additive of a suds controlling agent, or mixtures thereof, preferably from 0.1% to 1.5% and most preferably from 0.1% to 0.8%.

Stabilisers

The laundry additives of the present invention may further comprise a stabiliser.

Where present the stabiliser is present at a level of up to 10%, preferably from 2% to 4% by weight of the total laundry additive of an alcohol according to the formula HO—CR′ R″—OH, wherein R′ and R″ are independently H or a C2-C10 hydrocarbon chain and/or cycle. Preferred alcohol according to that formula is propanediol. Indeed, we have observed that these alcohols in general and propanediol in particular also improve the chemical stability of the laundry additives.

Other stabilizers like inorganic stabilizers may be used herein. Examples of inorganic stabilizers include sodium stannate and various alkali metal phosphates such as the well-known sodium tripolyphosphates, sodium pyrophosphate and sodium orthophosphate.

Suds booster

If high sudsing is desired, suds boosters such as C₁₀-C₁₆ alkanolamides can be incorporated into the laundry additives, typically at 1%-10% levels. The C₁₀-C₁₄ monoethanol and diethanol amides illustrate a typical class of such suds boosters. Use of such suds boosters with high sudsing adjunct surfactants such as the amine oxides, betaines and sultaines noted above is also advantageous. If desired, soluble magnesium salts such as MgCl₂, MgSO₄, and the like, can be added at levels of, for example, 0.1%-2%, to provide additional suds and to enhance grease removal performance.

Bleaching components

The laundry additives herein may also comprise a bleaching component. Any bleach known to those skilled in the art may be suitable to be used herein including any peroxygen bleach as well as a chlorine releasing component.

Suitable peroxygen bleaches for use herein include hydrogen peroxide or sources thereof. As used herein a source of hydrogen peroxide refers to any compound which produces active oxygen when said compound is in contact with water. Suitable water-soluble sources of hydrogen peroxide for use herein include percarbonates, preformed percarboxylic acids, persilicates, persulphates, perborates, organic and inorganic peroxides and/or hydroperoxides.

Suitable chlorine releasing component for use herein is an alkali metal hypochlorite or a dichloroisocyanurate. Advantageously, the laundry additive of the invention are stable in presence of this bleaching component., other hypochlorite compounds may also be used herein and can be selected from calcium and magnesium hypochlorite. Preferred are sodium dichloro isocyanurate and calcium hypohclorite.

Bleach activators

The laundry additives of the present invention that comprise a peroxygen bleach may further comprise a bleach activator or mixtures thereof. By “bleach activator”, it is meant herein a compound which reacts with peroxygen bleach like hydrogen peroxide to form a peracid. The peracid thus formed constitutes the activated bleach. Suitable bleach activators to be used herein include those belonging to the class of esters, amides, imides, or anhydrides. Examples of suitable compounds of this type are disclosed in British Patent GB 1 586 769 and GB 2 143 231 and a method for their formation into a prilled form is described in European Published Patent Application EP-A-62 523. Suitable examples of such compounds to be used herein are tetracetyl ethylene diamine (TAED), sodium 3,5,5 trimethyl hexanoyloxybenzene sulphonate, diperoxy dodecanoic acid as described for instance in U.S. Pat. No.4 818 425 and nonylamide of peroxyadipic acid as described for instance in U.S. Pat. No.4 259 201 and n-nonanoyloxybenzenesulphonate (NOBS). Also suitable are N-acyl caprolactams selected from the group consisting of substituted or unsubstituted benzoyl caprolactam, octanoyl caprolactam, nonanoyl caprolactam, hexanoyl caprolactam, decanoyl caprolactam, undecenoyl caprolactam, formyl caprolactam, acetyl caprolactam, propanoyl caprolactam, butanoyl caprolactam pentanoyl caprolactam or mixtures thereof. A particular family of bleach activators of interest was disclosed in EP 624 154, and particularly preferred in that family is acetyl triethyl citrate (ATC). Acetyl triethyl citrate has the advantage that it is environmental-friendly as it eventually degrades into citric acid and alcohol. Furthermore, acetyl triethyl citrate has a good hydrolytical stability in the product upon storage and it is an efficient bleach activator. Finally, it provides good building capacity to the laundry additive.

Metal-containing bleach catalyst

The laundry additive described herein which contain bleach as an optional component may additionally contain as a preferred component, a metal containing bleach catalyst. Preferably the metal containing bleach catalyst is a transition metal containing bleach catalyst, more preferably a manganese or cobalt-containing bleach catalyst.

The laundry additives of the present invention may comprise an effective amount of a bleach catalyst. The term “an effective amount” is defined as “an amount of the transition-metal bleach catalyst present in the present invention laundry additives, or during use according to the present invention methods, that is sufficient, under whatever comparative or use conditions are employed, to result in at least partial oxidation of the material sought to be oxidized by the laundry additive or method.”

Preferably the laundry additives of the present invention comprise from 1 ppb (0.0000001%), more preferably from 100 ppb (0.00001%), yet more preferably from 500 ppb (0.00005%), still more preferably from 1 ppm (0.0001%) to 99.9%, more preferably to 50%, yet more preferably to 5%, still more preferably to 500 ppm (0.05%) by weight of the laundry additive, of a metal bleach catalyst as described herein below.

A suitable type of bleach catalyst is a catalyst comprising a heavy metal cation of defined bleach catalytic activity, such as copper, iron cations, an auxiliary metal cation having little or no bleach catalytic activity, such as zinc or aluminium cations, and a sequestrant having defined stability constants for the catalytic and auxiliary metal cations, particularly ethylenediaminetetraacetic acid, ethylenediaminetetra(methylenephosphonic acid) and water-soluble salts thereof. Such catalysts are disclosed in U.S. Pat. No. 4,430,243.

Preferred types of bleach catalysts include the manganese-based or cobalt-based complexes.

Disinfecting agent

Another preferred component of the compositions of the present invention is a disinfecting agent. Any suitable known disinfecting agent may be used herein including organic acids, quaternary ammonium compounds, antimicrobial essential oils or actives thereof, or a mixtures thereof.

Preferred therein include organic acids, antimicrobial essential oils or actives thereof, or a mixtures thereof. Preferred organic acids include citric acid, tartaric acid, salicylic acid, lactic acid and mixtures thereof.

Suitable antimicrobial essential oils to be used herein are those essential oils which exhibit antimicrobial activity. By “actives of essential oils”, it is meant herein any ingredient of essential oils or natural extracts that exhibit antimicrobial activity. It is speculated that said antimicrobial essential oils and actives thereof act as proteins denaturing agents. Also said antimicrobial oils and actives thereof are compounds which contribute to the safety profile of a composition comprising them when it is used to disinfect any surface. A further advantage of said antimicrobial oils and actives thereof is that they impart pleasant odor to a composition comprising them without the need of adding a perfume.

Such antimicrobial essential oils include, but are not limited to, those obtained from thyme, lemongrass, citrus, lemons, oranges, anise, clove, aniseed, pine, cinnamon, geranium, roses, mint, lavender, citronella, eucalyptus, peppermint, camphor, ajowan, sandalwood, rosmarin, vervain, fleagrass, lemongrass, ratanhiae, cedar, origanum, cypressus, propolis extracts and mixtures thereof. Preferred antimicrobial essential oils to be used herein are thyme oil, clove oil, cinnamon oil, geranium oil, eucalyptus oil, peppermint oil, citronella oil, ajowan oil, mint oil, origanum oil, propolis, cypressus oil cedar, garlic extract or mixtures thereof.

Actives of essential oils to be used herein include, but are not limited to, thymol (present for example in thyme, ajowan), eugenol (present for example in cinnamon and clove), menthol (present for example in mint), geraniol (present for example in geranium and rose, citronella), verbenone (present for example in vervain), eucalyptol and pinocarvone (present in eucalyptus), cedrol (present for example in cedar), anethol (present for example in anise), carvacrol, hinokitiol, berberine, ferulic acid, cinnamic acid, methyl salicylic acid, methyl salycilate, terpineol, limonene and mixtures thereof. Preferred actives of essential oils to be used herein are thymol, eugenol, verbenone, eucalyptol, terpineol, cinnamic acid, methyl salicylic acid, limonene, geraniol, ajolene or mixtures thereof.

Thymol may be commercially available for example from Aldrich, eugenol may be commercially available for example from Sigma, Systems-Bioindustries (SBI)-Manheimer Inc.

Typically, the antimicrobial essential oil or active thereof or mixture thereof is present in the composition at a level of at least 0.001% by weight of the total composition, preferably from 0.006% to 10%, more preferably from 0.01% to 8% and most preferably of from 0.03% to 3%. It has now been found that combining said antimicrobial essential oil or an active thereof or a mixture thereof with a peroxygen bleach, in a composition, delivers not only excellent immediate disinfecting properties to the surfaces treated with said composition, but also long lasting disinfecting properties. Indeed, it is speculated that peroxygen bleach and said essential oils/actives adsorb on a surface having been treated with said composition and thus reduce or even prevent the contamination of microorganisms over time, typically up to 48 hours after the surface has been treated with said composition, thereby delivering long lasting disinfection. In other words, it is speculated that a microfilm of said active ingredients is deposited on the surface treated with said compositions allowing protection against microorganisms recontamination overtime. Advantageously, this long lasting disinfection benefits is obtained with the compositions of the present invention comprising peroxygen bleach and antimicrobial essential oils/actives even when used under highly diluted conditions, i.e., up to dilution levels of from 1:100 (composition:water).

Excellent long lasting disinfection is obtained by treating a surface with a composition comprising a peroxygen bleach and an antimicrobial essential oil or active thereof as described herein, on a variety of microorganisms, e.g., the growth of Gram positive bacteria like Staphylococcus aureus, and Gram negative bacteria like Pseudomonas aeroginosa as well as of fungi like Candida albicans is reduced or even prevented on a surface having been treated with said composition.

Long lasting disinfection properties of the compositions herein may be measured by the bactericidal activity of said compositions. A test method suitable to evaluate the long lasting bactericidal activity of a composition may be as follow: First, the surfaces (e.g. glass) to be tested are respectively treated with either a composition according to the present invention or a reference composition, e.g., a negative control composed of pure water (for example by spraying the composition directly on the surface or first spraying the composition on a sponge used to clean the surface or when the composition herein is executed in the form of wipe by wiping the surface therewith). After a variable time frame (e.g. 24 hours) each surface is respectively inoculated with bacteria (10⁶⁻⁷cfu/slide) cultured in for example TSB (Tryptone Soya Broth) and left typically from a few seconds to 2 hours before evaluating the remaining living bacteria. Then living bacteria (if any) are recovered from the surface (by touching TSA+neutraliser plates and by re-suspending the bacteria into the neutralisation broth and plating them on agar) and incubated at appropriate temperature, e.g. 37° C. to let them grow typically over night. Finally, a visual grading of the living bacteria is made by comparing side by side the cultures and/or dilutions thereof (e.g. 10⁻² or 10⁻¹) resulting from the surfaces treated with the compositions according to the present invention and the reference composition.

In a particular embodiment of the present invention, depending on the end use desired with said compositions they may further comprise, as optional ingredients, other antimicrobial compounds that further contribute to the antimicrobial/antibacterial activity of the compositions according to the present invention. Such antimicrobial ingredients include parabens like ethyl paraben, propyl paraben, methyl paraben, glutaraldehyde or mixtures thereof.

Enzymes

Enzymes are optional, but preferred components of the laundry additives as disclosed herein. Where present said enzymes are selected from the group consisting of cellulases, hemicellulases, peroxidases, proteases, gluco-amylases, amylases, xylanases, lipases, phospholipases, esterases, cutinases, pectinases, keratanases, reductases, oxidases, phenoloxidases, lipoxygenases, ligninases, pullulanases, tannases, pentosanases, malanases, β-glucanases, arabinosidases, hyaluronidase, chondroitinase, laccase or mixtures thereof.

Preferred enzymes include protease, amylase, lipase, peroxidases, cutinase and/or cellulase in conjunction with one or more plant cell wall degrading enzymes.

The cellulases usable in the present invention include both bacterial or fungal cellulase. Preferably, they will have a pH optimum of between 5 and 12 and an activity above 50 CEVU (Cellulose Viscosity Unit). Suitable cellulases are disclosed in U.S. Pat. No. 4,435,307, Barbesgoard et al, J61078384 and WO96/02653 which disclose fungal cellulases produced respectively from Humicola insolens, Trichoderma, Thielavia and Sporotrichum. EP 739 982 describes cellulases isolated from novel Bacillus species. Suitable cellulases are also disclosed in GB-A-2.075.028; GB-A-2.095.275; DE-OS-2.247.832 and WO95/26398.

Examples of such cellulases are cellulases produced by a strain of Humicola insolens (Humicola grisea var. thermoidea), particularly the Humicola strain DSM 1800. Other suitable cellulases are cellulases originated from Humicola insolens having a molecular weight of 50 KDa, an isoelectric point of 5.5 and containing 415 amino acids; and a ^{˜}43 kD endoglucanase derived from Humicola insolens, DSM 1800, exhibiting cellulase activity; a preferred endoglucanase component has the amino acid sequence disclosed in PCT Patent Application No. WO 91/17243. Also suitable cellulases are the EGIII cellulases from Trichoderma longibrachiatum described in WO94/21801, Genencor, published Sep. 29, 1994. Especially suitable cellulases are the cellulases having color care benefits. Examples of such cellulases are cellulases described in European patent application No. 91202879.2, filed Nov. 6, 1991 (Novo). Carezyme® and Celluzyme® (Novo Nordisk A/S) are especially useful. See also WO91/17244 and WO91/21801. Other suitable cellulases for fabric care and/or cleaning properties are described in WO96/34092, WO96/17994 and WO95/24471.

Said cellulases are normally incorporated in the laundry additives at levels from 0.0001% to 2% of active enzyme by weight of the laundry additives.

Peroxidase enzymes are used in combination with oxygen sources, e.g. percarbonate, perborate, persulfate, hydrogen peroxide, etc. They are used for “solution bleaching”, i.e. to prevent transfer of dyes or pigments removed from substrates during wash operations to other substrates in the wash solution. Peroxidase enzymes are known in the art, and include, for example, horseradish peroxidase, ligninase and haloperoxidase such as chloro- and bromo-peroxidase. Peroxidase-containing detergent laundry additives are disclosed, for example, in PCT International Application WO 89/099813, WO89/09813 and in European Patent application EP No. 91202882.6, filed on Nov. 6, 1991 and EP No. 96870013.8, filed Feb. 20, 1996. Also suitable is the laccase enzyme.

Preferred enhancers are substitued phenthiazine and phenoxasine 10-Phenothiazinepropionicacid (PPT), 10-ethylphenothiazine-4-carboxylic acid (EPC), 10-phenoxazinepropionic acid (POP) and 10-methylphenoxazine (described in WO 94/12621) and substitued syringates (C3-C5 substitued alkyl syringates) and phenols. Sodium percarbonate or perborate are preferred sources of hydrogen peroxide.

Said cellulases and/or peroxidases are normally incorporated in the laundry additives at levels from 0.0001% to 2% of active enzyme by weight of the laundry additives.

Other preferred enzymes that can be included in the laundry additives of the present invention include lipases. Suitable lipase enzymes for detergent usage include those produced by microorganisms of the Pseudomonas group, such as Pseudomonas stutzeri ATCC 19.154, as disclosed in British Patent 1,372,034. Suitable lipases include those which show a positive immunological cross-reaction with the antibody of the lipase, produced by the microorganism Pseudomonas fluorescent IAM 1057. This lipase is available from Amano Pharmaceutical Co. Ltd., Nagoya, Japan, under the trade name Lipase P “Amano,” hereinafter referred to as “Amano-P”. Other suitable commercial lipases include Amano-CES, lipases ex Chromobacter viscosum, e.g. Chromobacter viscosum var. lipolyticum NRRLB 3673 from Toyo Jozo Co., Tagata, Japan; Chromobacter viscosum lipases from U.S. Biochemical Corp., U.S.A. and Disoynth Co., The Netherlands, and lipases ex Pseudomonas gladioli. Especially suitable lipases are lipases such as M1 Lipase® and Lipomax® (Gist—Brocades) and Lipolase® and Lipolase Ultra® (Novo) which have found to be very effective. Also suitables are the lipolytic enzymes described in EP 258 068, WO 92/05249 and WO 95/22615 by Novo Nordisk and in WO 94/03578, WO 95/35381 and WO 96/00292 by Unilever.

Also suitable are cutinases [EC 3.1.1.50] which can be considered as a special kind of lipase, namely lipases which do not require interfacial activation. Addition of cutinases to detergent laundry additives has been described in e.g. WO-A-88/09367 (Genencor); WO 90/09446 (Plant Genetic System) and WO 94/14963 and WO 94/14964 (Unilever).

The lipases and/or cutinases are normally incorporated in the laundry additives at levels from 0.0001% to 2% of active enzyme by weight of the laundry additives.

Suitable proteases are the subtilisins which are obtained from particular strains of B. subtilis and B. licheniformis (subtilisin BPN and BPN′). One suitable protease is obtained from a strain of Bacillus, having maximum activity throughout the pH range of 8-12, developed and sold as ESPERASE® by Novo Industries A/S of Denmark, hereinafter “Novo”. The preparation of this enzyme and analogous enzymes is described in GB 1,243,784 to Novo. Other suitable proteases include ALCALASE(®, DURAZYM® and SAVINASE® from Novo and MAXATASE®, MAXACAL®, PROPERASE® and MAXAPEM® (protein engineered Maxacal) from Gist—Brocades. Proteolytic enzymes also encompass modified bacterial serine proteases, such as those described in European Patent Application Serial Number 87 303761.8, filed Apr. 28, 1987 (particularly pages 17, 24 and 98), and which is called herein “Protease B”, and in European Patent Application 199,404, Venegas, published Oct. 29,1986, which refers to a modified bacterial serine protealytic enzyme which is called “Protease A” herein. Suitable is what is called herein “Protease C”, which is a variant of an alkaline serine protease from Bacillus in which lysine replaced arginine at position 27, tyrosine replaced valine at position 104, serine replaced asparagine at position 123, and alanine replaced threonine at position 274. Protease C is described in EP 90915958:4, corresponding to WO 91/06637, Published May 16, 1991. Genetically modified variants, particularly of Protease C, are also included herein.

A preferred protease referred to as “Protease D” is a carbonyl hydrolase variant having an amino acid sequence not found in nature, which is derived from a precursor carbonyl hydrolase by substituting a different amino acid for a plurality of amino acid residues at a position in said carbonyl hydrolase equivalent to position +76, preferably also in combination with one or more amino acid residue positions equivalent to those selected from the group consisting of +99, +101, +103, +104, +107, +123, +27, +105, +109, +126, +128, +13 +197, +204, +206, +210, +216, +217, +218, +222, +260, +2 according to the numbering of Bacillus amyloliquefaciens subtilisin, as described in WO95/10591 and in the patent application of C. Ghosh, et al, “Bleaching Compositions Comprising Protease Enzymes” having U.S. Ser. No. 08/322,677, filed Oct. 13, 1994.

Also suitable for the present invention are proteases described in patent applications EP 251 446 and WO 91/06637, protease BLAP® described in WO91/02792 and their variants described in WO 95/23221. See also a high pH protease from Bacillus sp. NCIMB 40338 described in WO 93/18140 A to Novo. Enzymatic detergents comprising protease, one or more other enzymes, and a reversible protease inhibitor are described in WO 92/03529 A to Novo. When desired, a protease having decreased adsorption and increased hydrolysis is available as described in WO 95/07791 to Procter & Gamble. A recombinant trypsin-like protease for detergents suitable herein is described in WO 94/25583 to Novo. Other suitable proteases are described in EP 516 200 by Unilever.

Other preferred protease enzymes include protease enzymes which are a carbonyl hydrolase variant having an amino acid sequence not found in nature, which is derived by replacement of a plurality of amino acid residues of a precursor carbonyl hydrolase with different amino acids, wherein said plurality of amino acid residues replaced in the precursor enzyme correspond to position +210 in combination with one or more of the following residues: +33, +62, +67, +76, +100, +101, +103, +104, +107, +128, +129, +130, +13 +164, +166, +167, +170, +209, +215, +217, +218 and +222, where numbered positions correspond to naturally-occurring subtilisin from Bacillus amyloliquefaciens or to equivalent amino acid residues in other carbonyl hydrolases or subtilisins (such as Bacillus lentus subtilisin). Preferred enzymes of this type include those having position changes +210, +76, +103, +104, +156, and +166.

The proteolytic enzymes are incorporated in the laundry additives of the present invention a level of from 0.0001% to 2%, preferably from 0.001% to 0.2%, more preferably from 0.005% to 0.1% pure enzyme by weight of the laundry additive.

Amylases (α and/or β) can be included for removal of carbohydrate-based stains. WO94/02597, Novo Nordisk A/S published Feb. 03, 1994, describes cleaning compositions which incorporate mutant amylases. See also WO95/10603, Novo Nordisk A/S, published Apr. 20, 1995. Other amylases known for use in cleaning compositions include both α- and β-amylases. α-Amylases are known in the art and include those disclosed in US Pat. no. 5,003,257; EP 252,666; WO/91/00353; FR 2,676,456; EP 285,123; EP 525,610; EP 368,341; and British Patent specification no.1,296,839 (Novo). Other suitable amylases are stability-enhanced amylases described in WO94/18314, published Aug. 18, 1994 and WO96/05295, Genencor, published Feb. 22, 1996 and amylase variants having additional modification in the immediate parent available from Novo Nordisk A/S, disclosed in WO 95/10603, published Apr. 95. Also suitable are amylases described in EP 277 216, WO95/26397 and WO96/23873 (all by Novo Nordisk).

Examples of commercial α amylases products are Purafect Ox Am® from Genencor and Termamyl®, Ban®,Fungamyl® and Duramyl®, Natalase ® all available from Novo Nordisk A/S Denmark. WO95/26397 describes other suitable amylases : α-amylases characterised by having a specific activity at least 25% higher than the specific activity of Termamyl® at a temperature range of 25° C. to 55° C. and at a pH value in the range of 8 to 10, measured by the Phadebas® α-amylase activity assay. Suitable are variants of the above enzymes, described in WO96/23873 (Novo Nordisk). Other amylolytic enzymes with improved properties with respect to the activity level and the combination of thermostability and a higher activity level are described in WO95/35382.

Preferred amylase enzymes include those described in WO95/26397 and in co-pending application by Novo Nordisk PCT/DK96/00056.

The amylolytic enzymes are incorporated in the laundry additives of the present invention a level of from 0.0001% to 2%, preferably from 0.00018% to 0.06%, more preferably from 0.00024% to 0.048% pure enzyme by weight of the laundry additive

In a particularly preferred embodiment, detergent laundry additives of the present invention comprise amylase enzymes, particularly those described in WO95/26397 and co-pending application by Novo Nordisk PCT/DK96/00056 in combination with a complementary amylase.

By “complementary” it is meant the addition of one or more amylase suitable for detergency purposes. Examples of complementary amylases (αand/or β) are described below. WO94/02597 and WO95/10603, Novo Nordisk A/S describe cleaning compositions which incorporate mutant amylases. Other amylases known for use in cleaning compositions include both α- and β-amylases. α-Amylases are known in the art and include those disclosed in US Pat. no. 5,003,257; EP 252,666; WO/91/00353; FR 2,676,456; EP 285,123; EP 525,610; EP 368,341; and British Patent specification no. 1,296,839 (Novo). Other suitable amylases are stability-enhanced amylases described in WO94/18314, and WO96/05295, Genencor and amylase variants having additional modification in the immediate parent available from Novo Nordisk A/S, disclosed in WO 95/10603. Also suitable are amylases described in EP 277 216 (Novo Nordisk). Examples of commercial α-amylases products are Purafect Ox Am® from Genencor and Termamyl®, Ban®,Fungamyl® and Duramyl®, all available from Novo Nordisk A/S Denmark. WO95/26397 describes other suitable amylases: α-amylases characterised by having a specific activity at least 25% higher than the specific activity of Termamyl® at a temperature range of 25° C. to 55° C. and at a pH value in the range of 8 to 10, measured by the Phadebas® α-amylase activity assay. Suitable are variants of the above enzymes, described in WO96/23873 (Novo Nordisk). Other amylolytic enzymes with improved properties with respect to the activity level and the combination of thermostability and a higher activity level are described in WO95/35382. Preferred complementary amylases for the present invention are the amylases sold under the tradename Purafect Ox Am^{R} described in WO 94/18314, WO96/05295 sold by Genencor; Termamyl®, Fungamyl®, Ban® Natalase® and Duramyl®, all available from Novo Nordisk A/S and Maxamyl® by Gist—Brocades.

Said complementary amylase is generally incorporated in the laundry additives of the present invention a level of from 0.0001% to 2%, preferably from 0.00018% to 0.06%, more preferably from 0.00024% to 0.048% pure enzyme by weight of the laundry additive. Preferably a weight of pure enzyme ratio of specific amylase to the complementary amylase is comprised between 9:1 to 1:9, more preferably between 4:1 to 1:4, and most preferably between 2:1 and 1:2.

The above-mentioned enzymes may be of any suitable origin, such as vegetable, animal, bacterial, fungal and yeast origin. Origin can further be mesophilic or extremophilic (psychrophilic, psychrotrophic, thermophilic, barophilic, alkalophilic, acidophilic, halophilic, etc.). Purified or non-purified forms of these enzymes may be used. Also included by definition, are mutants of native enzymes. Mutants can be obtained e.g. by protein and/or genetic engineering, chemical and/or physical modifications of native enzymes. Common practice as well is the expression of the enzyme via host organisms in which the genetic material responsible for the production of the enzyme has been cloned.

Said enzymes are normally incorporated in the laundry additives herein at levels from 0.0001% to 2% of active enzyme by weight of the laundry additives. The enzymes can be added as separate single ingredients (prills, granulates, stabilized liquids, etc. containing one enzyme ) or as mixtures of two or more enzymes (e.g. cogranulates ).

Other suitable detergent ingredients that can be added are enzyme oxidation scavengers which are described in Copending European Patent application 92870018.6 filed on Jan. 31, 1992. Examples of such enzyme oxidation scavengers are ethoxylated tetraethylene polyamines.

A range of enzyme materials and means for their incorporation into synthetic detergent compositions is also disclosed in WO 9307263 A and WO 9307260 A to Genencor International, WO 8908694 A to Novo, and U.S. Pat. No. 3,553,139, Jan. 5, 1971 to McCarty et al. Enzymes are further disclosed in U.S. Pat. No. 4,101,457, Place et al, Jul. 18, 1978, and in U.S. Pat. No. 4,507,219, Hughes, Mar. 26, 1985. Enzyme materials useful for liquid detergent formulations, and their incorporation into such formulations, are disclosed in U.S. Pat. No. 4,261,868, Hora et al, Apr. 14, 1981. Enzymes for use in detergents can be stabilised by various techniques. Enzyme stabilisation techniques are disclosed and exemplified in U.S. Pat. No. 3,600,319, Aug. 17, 1971, Gedge et al, EP 199,405 and EP 200,586, Oct. 29, 1986, Venegas. Enzyme stabilisation systems are also described, for example, in U.S. Pat. No. 3,519,570. A useful Bacillus, sp. AC13 giving proteases, xylanases and cellulases, is described in WO 9401532 A to Novo.

Process of treating fabrics

The process of washing dyed fabrics according to the present invention comprises the steps of diluting, dissolving or dispersing a conventional detergent composition in a bath of wash water and adding the laundry additive sachet according to the present invention to the wash water and subsequently contacting said dyed fabrics with said wash water.

By “substantially diluted, dissolved or dispersed” it is meant herein, that at least 50%, preferably at least 80%, more preferably at least 90%, even more preferably at least 95%, still more preferably at least 98%, and most preferably at least 99%, of said conventional laundry detergent are diluted, dissolved or dispersed in the aqueous bath formed in the process according to the present invention.

The term “bath” as used herein to define any suitable receptacle for the water, conventional detergent composition and sachet of the present invention. Such a receptacle may for example be a bath tub or a bucket. Alternatively, the receptacle may be a washing machine. In this embodiment, the conventional detergent composition is charged to the washing machine by way of the dispenser drawer of the washing machine or by directly charging the drum of the washing machine. The sachet is loaded directly into the drum of the washing machine. More preferably the conventional laundry detergent and the sachet are both directly placed into the drum of the washing machine.

By “conventional laundry detergent” it is meant herein, a laundry detergent composition currently available on the market. Preferably, said conventional laundry detergent comprises at least one surfactant. Said laundry detergent compositions may be formulated as powders, liquids or tablets. Suitable laundry detergent compositions are for example DASH futur®, DASH liquid®, ARIEL tablets® and other products sold under the trade names ARIEL® or TIDE®.

### EXAMPLES

Provided below are example of the Laundry Additive Sachet according to the present invention. These examples however are in no way meant to be limiting.

A] A sachet manufactured from cotton yarn defining a cavity, the cavity containing 10 g of water insoluble granular cross-linked PVNO.

B] A sachet manufactured from a non-woven web of polyethylene fibers (PET) defining a cavity, the cavity containing log of water insoluble granular cross-linked PVNO and 2 grams of granular citric acid.

C] A sachet manufactured from a non-woven web of polyethylene fibers (PET) defining a cavity, the cavity containing a cotton sheet impregnated with 8 grams of glycidyl trimethyl ammonium chloride and 0.2 grams of HEDP. The glycidyl trimethyl ammonium chloride and HEDP were applied to the cotton sheet in liquid form.

D] A sachet manufactured from a non-woven web of polyethylene fibers (PET) defining a cavity, the cavity containing 6g of water insoluble granular cross-linked PVNO, 2 grams of Dobanol 91-8 (nonionic surfactant) and 10 grams of granular sodium percarbonate bleach. Dobanol 91-8 is used in Liquid form an is applied onto the granular PVNO. Sodium percarbonate is added to the laundry additive composition after the surfactant has been applied to the PVNO and dried.

What is claimed is:

1. A laundry additive sachet comprising a laundry additive being located in a cavity of said sachet; wherein said laundry additive comprises a dye absorbing agent and/or a dirt binding agent.

2. A laundry additive sachet according to claim 1 wherein said sachet is water permeable and insoluble.

3. A laundry additive sachet according to claim 1 wherein said dye absorbing and/or said dirt binding agent is a compound that irreversibly binds dirt and/or dye.

4. A laundry additive sachet according to claim 1 wherein said sachet is manufactured from a web of woven or non-woven, synthetic, man-made, and/or natural fibres.

5. A laundry additive sachet according to claim 1 wherein said sachet is manufactured from fibres selected from the group consisting of polyurethane, polypropylene, polyester, polyethylene, polyamide, polyethylene tetraphthalate (PET), cellulose, derivatives of cellulose, and mixtures thereof.

6. A laundry additive sachet according to claim 1 wherein said dye absorbing agent and/or said dirt binding agent are selected from the group consisting of ethoxylated cationic diamine, ethoxylated cationic polyamine, ethoxylated cationic amine polymers, polymers/co-polymers of maleic/acrylic acid, polyacrylic-maleic phosphono-end group copolymer, quaternary ammonium-hydroxy-haloalkyl, epoxyalkyl ammonium, polyquaternary ammonium, polyamphoterics, cationic starches, proteins, chitin, chitosan, polyvinyl amine, polyethylene imine, polyethoxylated-quaternized-sulfated amine polyvinylpyrrolidone, polyvinyl pyridine-N-oxide (PVNO), crosslinked PVNO (XL-PVNO), Poly vinyl imidazol, polyvinyl alcohol, polyamine-N-oxide, PVPPVAmine, magnesium aluminate, poly ethylene imines, polyvinyl oxazolidone, cationic surfactants, amphoteric surfactants, and mixtures thereof.

7. A laundry additive sachet according to claim 1 wherein said dye absorbing agent is selected from the group consisting of XL-PVNO, Tinofix FRD, and mixtures thereof.

8. A laundry additive sachet according to claim 1 wherein said dirt binding agent is selected form the group consisting of XL-PVNO, acrylic acid/maleic acid copolymers having molecular weight between 1000 and 1.000.000, ethoxylated cationic diamine, and mixtures thereof.

9. A laundry additive sachet according to claim 1 wherein said dye absorbing agent and/or said dirt binding agent is a compound that performs both functions.

10. A laundry additive sachet according to claim 1 wherein said dye absorbing agent and/or said dirt binding agent is supported on a carrier.

11. A laundry additive sachet according to claim 10 wherein said carrier is a cotton sheet.

12. A laundry additive sachet according to claim 10 wherein said carrier and said dye absorbing agent provide a visual indication of the scavenging of any fugitive dyes.

13. A laundry additive sachet according to claim 1 further comprising a water softening agent.

14. A laundry additive sachet according to claim 13 wherein said water softening agent is selected from the group consisting of ion exchange resin, builders, anti-encrustation agents, and mixtures thereof

15. A laundry additive sachet according to claim 1 further comprising brighteners, bleaching agents, bleach activators, bleach catalysts, chelating agents, surfactants, perfumes, disinfecting agents, enzymes, or mixtures thereof.

16. A process of washing dyed fabrics comprising the steps of diluting, dissolving, or dispersing a conventional detergent composition in a bath of wash water and adding the laundry additive sachet according to claim 1 to said wash water and subsequently contacting said dyed fabrics with said wash water.
